(19) United States
(12) Patent Application Publication
(10) Pub. No.: US 2026/0127470 A1
(43) Pub. Date: May 7, 2026

(54) PREVENTION OF QUBIT DECOHERENCE USING ACTIVE FEEDBACK CIRCUITS

(71) Applicant: EeroQ Corporation, Chicago, IL (US)

(72) Inventors: Gerwin Koolstra, Chicago, IL (US); Elena O. Glen, Chicago, IL (US)

(21) Appl. No.: 18/930,035

(22) Filed: Oct. 29, 2024

Related U.S. Application Data
(60) Provisional application No. 63/596,730, filed on Nov. 7, 2023.

(51) Int. Cl. G06N 10/40

(52) U.S. Cl. CPC G06N 10/40

(57) ABSTRACT

Disclosed are systems and techniques to improve coherence of qubits experiencing fluctuating electric potential caused by the environment. In some implementations, a processing device implementing the disclosed techniques includes a first (second) qubit structure formed using a first (second) set of electrodes electrostatically confining a first (second) electron in a direction lateral to a film, the film including a condensed phase of one or more inert gas elements. The processing device further includes a feedback circuitry to subject the first qubit structure to a probe signal, receive a response signal caused by an interaction of the probe signal with the first qubit structure, generate, using the response signal, a correction signal, and subject the first qubit structure and the second qubit structure to the correction signal.

### RELATED APPLICATIONS

This application claims benefit of the U.S. Provisional Patent Application No. 63/596,730 filed Nov. 7, 2023, the contents of which are incorporated in their entirety by reference herein.

### TECHNICAL FIELD

The instant specification generally relates to systems and methods for creating qubit hardware and mechanisms for qubit control and readout for implementing quantum computing technology.

### BACKGROUND

Quantum computing is the technology that utilizes quantum bits (qubits)—quantum systems that can be in a superposition state α|0 [symbol] +β|1 [symbol] of two quantum states, |0 [symbol] and |1 [symbol] , with continuously varying parameters α and β, unlike classical bits that always remain in one of the two classical states, 0 or 1. Operation of a quantum computer may include preparing multiple qubit states, achieving quantum entanglement of two or more separate qubits, causing quantum evolution of the system of entangled qubits in accord with a quantum algorithm (code) tailored to a particular task being undertaken, performing quantum readout of the end state of the entangled qubits, and—given the intrinsically probabilistic nature of quantum systems—applying suitable error-correction techniques. Quantum computers can be superior to classical computers for a number of problems (such as prime number factorization, unstructured searching, optimization, etc.) that would not be practicable on classical computers or would require exponentially large computational resources. Despite various proposed realizations of qubits and readout methods, reliable implementation of scalable quantum computing remains an outstanding technological challenge. To be feasible for actual quantum computations, qubits should have minimal coupling to extraneous objects, in order to avoid decoherence of quantum states of qubits. In particular, qubits should be able to retain their quantum coherence over times that are sufficiently long for the quantum algorithm execution and the final state readout. On the other hand, it should be possible to maintain a degree of external control over individual qubits, to prepare initial states of the qubits and to read out their final states. Successfully balancing these countervailing objectives for a large number of qubits is one or prerequisites of advanced quantum computing applications.

### DESCRIPTION OF DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are presented for explanation and understanding purposes only.

FIG. 1 illustrates schematically an example system that may serve as a reservoir of electrons for qubits and that uses liquid helium and electrostatic gates to facilitate electron confinement, according to one implementation.

FIGS. 2A-2C illustrate schematically an example system that uses electrostatic gates to create electron traps and trap electrons confined near a surface of liquid helium, according to one implementation.

FIG. 3 illustrates an example structure that includes a data qubit and an ancillary qubit to implement an active feedback loop that prevents environmental decoherence of the data qubit, according to one implementation.

FIG. 4 is a schematic block diagram of an example active feedback system that compensates for environmental noise/fluctuations of electric potential and improves qubit coherence, according to one implementation.

FIG. 5 illustrates schematically compensation of fluctuations of electrostatic potential using the active feedback system of FIG. 4, according to one implementation.

FIG. 6 is a flow diagram illustrating an example method of improving qubit coherence by compensating for environmental noise/fluctuations of electric potential of qubits, according to one implementation.

### DETAILED DESCRIPTION

Among specific realizations of qubits are qubits that are implemented via electrons trapped near a surface of liquid helium and held to the vicinity of this surface by electrostatic forces, which may include image forces of attraction to helium and/or forces caused by electric fields of gate electrodes (normally positioned below the film of helium). Additional electrostatic gates may be used to laterally confine electrons to a bounded area and further to implement electron traps outside the bounded area to capture a small number of electrons therein. The number of electrons trapped in this manner may be controlled by electrostatic gating and, in some implementations, may be equal to one. Such individual electrons may be used as qubits. The quantum states of a qubit, |0 [symbol] and |1 [symbol] , may be realized, for example, as a ground state and an excited state of a trapped electron. In some implementations, the quantum states of the qubit may be vertical Rydberg motional states of the electron floating near the surface of liquid helium. In other implementations, the quantum states of the qubit may be due to quantized lateral motion of the electron inside the trap. Quantum computations may be performed by subjecting electrons of the qubits to external fields, e.g., static magnetic fields, radio-frequency (RF), and/or microwave (MW) fields (in the instances of single-qubit operations/gates), by bringing electrons from different qubits together and facilitating controlled-duration interactions of the electrons (multi-qubit operations/gates), and so on.

Quantum computations rely on maintaining coherence (phase of the wave function) of qubits for at least the duration necessary to perform qubit gate operations and a subsequent readout of the final qubit states. Various environmental effects and influences may shorten quantum coherence times significantly thus making performance of long and complex gate operations difficult or impossible. For example, fluctuations of the surface profile of helium films (e.g., caused by ever-present, even at very low temperatures, thermal ripplon waves) can result in random variations of the electric potential φ(x,y) across the area of the helium film. Such variations of the potential φ(x,y) cause accumulation of random phase changes that destroy qubit coherence (the faster the higher the amplitude of these random fluctuations is). Even at temperatures of about 10 mK, typical for qubit operations, ripplon vibrations cause a significant decoherence of helium-supported qubits. Additionally, microwave readout techniques rely on knowledge of a resonant frequency

$${v}_{0} = \frac{{E}_{1} - {E}_{0}}{h}$$

for the transitions between an excited state (energy E₁, with h being Planck's constant) and a ground state (energy E₀). If the resonant frequency v(t) varies unpredictably with time t, departing from v₀, qubit readout techniques will have low fidelity.

Aspects and implementations of the present disclosure address these and other challenges of the existing qubit-on-helium electron technology by providing for systems and techniques capable of implementing active feedback loops that prevent or reduce environmental decoherence of qubits. More specifically, a data qubit that is to be used with quantum gate operations may be paired with a proximally located ancillary qubit that is used for environmental monitoring. In particular, an RF/MW circuitry monitoring the ancillary qubit may continuously measure a susceptibility of the ancillary qubit to a suitable RF/MW signal, e.g., a probe RF/MW signal I₀(t)=A₀ cos vt of frequency v that is at (v=v_{RES}) or near (v≈v_{RES}) the resonant frequency v_{RES} of the ancillary qubit resonator circuitry, and may identify a response signal of the ancillary qubit, I(t)=A(t) cos(vt+φ(t)), where both the amplitude A(t) and the phase shift φ(t) may further be monitored by a suitable feedback controller. The amplitude A(t) and the phase shift φ (or, alternatively, real and imaginary parts) of the signal may jointly determine how far the current (time-varying) resonant frequency v_{RES}(t) of the ancillary qubit strays from the (fixed) frequency v of the probe signal. For example, as the difference v_{RES}(t)−v between the resonant frequency and the probe signal frequency changes from negative to positive values, the phase shift φ changes from near zero values φ≈0 to values close to φ≈π. A matching decrease in the amplitude A is observed when the difference v(t)−v increases (both for positive and negative values of this difference).

Using amplitude A and the phase shift φ, the feedback controller may determine a difference between the received response and a reference (set point) response and generate a correction signal, e.g., a voltage signal or a current signal. The correction signal, generated and configured by the feedback controller to reduce the difference may be provided to both the ancillary qubit and the data qubit. Since both qubits are positioned within the same locale of the helium film and, therefore, experience substantially the same ripplon (and other environmental) fluctuations, the correction signal that is configured to compensate for the random fluctuations of the ancillary qubit is similarly efficient in compensating random environmental fluctuations of the data qubit. On the other hand, the quantum state of the data qubit is not affected (unlike the ancillary qubit) by the continuous monitoring via the probe signal and is, therefore, capable of being used in quantum gate operations.

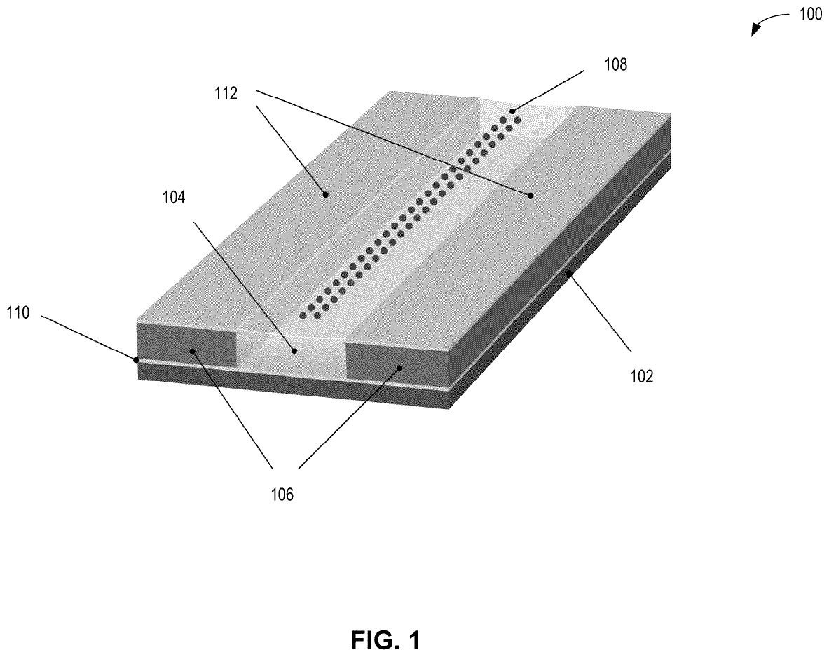

Numerous other implementations and techniques are set forth below. The advantages of the disclosed implementations include (but are not limited to) implementing helium-based qubits (and/or qubits formed using other inert gas materials, such as neon) that are robust against local and time-dependent environmental fluctuations/noise of the electric potential, including but not limited to fluctuations caused by thermal ripplons occurring in liquid films. Although the reference throughout description of FIGS. 1-6 below may be made to liquid helium, other types of inert gas materials in a condensed, e.g., liquid or solid, phase may be used, in some implementations, including but not limited to neon material, e.g., solid neon films.

FIG. 1 illustrates schematically an example system 100 that may serve as a reservoir of electrons for qubits and that uses liquid helium and electrostatic gates to facilitate electron confinement, according to one implementation. System 100 may be placed in a cryostat and maintained at a temperature that is below a condensation temperature for helium (or some other inert gas material). Liquid helium in system 100 may be supported by a substrate 102. In some implementations, substrate 102 may be a dielectric, e.g., silicon or sapphire. Substrate 102 may support a liquid helium film 104. The film of liquid helium may be restricted laterally from escaping substrate 102 by banks 106. In some implementations, banks 106 may be made of a dielectric material, which may be the same as or different from the material of substrate 102. For example, banks 106 may be made of silicon oxide. The banks may be deposited via thermal evaporation or sputtering. The thickness (height) of banks 106 may be used to determine the level of liquid film. In some implementations, banks 106 may have a thickness 0.2-1 μm, although in other implementations the thickness may be below or above this range. In some implementations, banks 106 may be so positioned as to form a microchannel of liquid helium, as illustrated in FIG. 1. The microchannel (or any other configuration of liquid helium film 104) may be filled with helium via capillary action using a source of helium (not shown explicitly on FIG. 1). The source of helium may be a low-lying bulk reservoir of helium.

Liquid helium film 104 may serve as a substrate to support electrons 108 floating above the surface of helium. Electrons 108 are repelled by the helium at short ranges. On the other hand, electrons 108 may be attracted to the surface of helium by long-range image attraction forces, which arise from interaction of the electron charge with the induced polarization of helium. Electrons 108 may further be confined to the surface of helium by electrostatic confinement forces applied by a bottom gate (electrode) 110, e.g., held at a positive potential. In some implementations, bottom gate 110 may be located on top of substrate 102. Bottom gate 110 may be made of a conducting material so that when a direct current (DC) voltage signal is applied to bottom gate 110, the entire bottom gate 110 acquires the same electric potential. In particular, by applying stronger positive voltages to bottom gate 110, electrons 108 may be brought closer to the surface of helium film. Conversely, weaker positive voltages applied to bottom gate 110 may result in electrons 108 being pushed further away from the surface of helium.

As a result, electrons 108 may be confined near the surface of liquid helium film 104 at controllable distances of about 50-100 Å from the surface of helium and have a binding energy of the order of one to ten (or more, in some implementations) meV.

In some implementations, electrons 108 may be initially deposited on the surface of helium by thermionic emission from a filament (e.g., a tungsten filament) located near (e.g., above the helium film). In other implementations, electrons may be produced via field emission or via photoemission. Once the electrons are deposited on the surface of helium, the density of electrons may be controlled by bottom gate 110. By varying the potential on bottom gate 110, an optimal density of electrons 108 on the surface of helium may be achieved. For example, by decreasing the potential on bottom gate 110, a fraction of electrons 108 may be pushed away. Conversely, upon increasing the potential on bottom gate 110, system 100 may keep more of electrons 108. At low densities, electrons 108 may be in a state of Wigner solid forming a regular crystal-like spatial arrangement, as schematically illustrated in FIG. 1. At high densities, electrons 108 may form an electron liquid state.

Further control over electrons 108 may be achieved via one or more top gates (electrodes) 112 which may be fabricated on top of (insulating) banks 106. Top gate(s) 112 may constrict motion of electrons 108 parallel to liquid helium film 104 by means of a lateral electrostatic confinement. For example, by applying a lower (e.g., negative) voltage to a pair of top gates 112, it may be possible to squeeze the electron channel together in the lateral direction. Conversely, by increasing the voltage applied to top gates 112, the lateral spread of the electron channel may be increased. To control the lateral spread and motion of electrons 108 (e.g., along the channel), additional gates (not explicitly shown in FIG. 1) may be used. Top gate 112 (as well as the bottom gate 110 and/or other gates) may be created from a variety of conducting materials. For example, the gates may be made of 5 nm of Ti and 45 nm of Au, in one implementation, but other designs of the gates are possible in other implementations. The gates may be thermally evaporated or sputtered onto the underlying substrate (e.g., a silicon or sapphire) banks 106, as illustrated by way of example in FIG. 1.

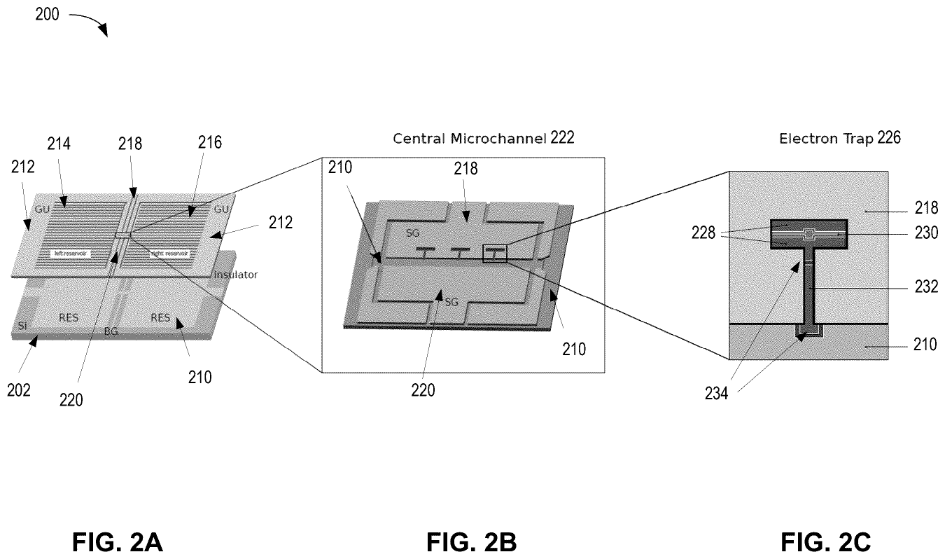

System 100 shown in FIG. 1 may be designed and manufactured in a variety of ways. Some of the components shown in FIG. 1 may be optional. In some implementations, system 100 may be mounted inside a cryostat (not shown) to sustain consistently low temperatures. In the cryostat, system 100 may be kept at temperatures below the boiling point of helium, 4.2 K. In some implementations, system 100 may be kept at temperatures below ⁴He superfluid transition temperature, 2.17 K. In some implementations, system 100 may be kept at significantly lower temperatures, for example below ³He superfluid transition temperature 0.0025 K. In some implementations, a cryogen-free ³He-⁴He dilution refrigerator may be used to achieve temperatures below 0.001 K. At such temperatures, spontaneous thermal transitions between different Rydberg electron states of the vertical confinement may be largely frozen out. The surface tension of liquid helium film 104 may play a stabilizing role and keep electrons 108 at fixed distances from various additional readout and control electrodes, which may be fabricated within the system (see description of FIGS. 2A-2C below). The stability of the surface of liquid helium film 104 may be further controlled by, for example, introducing controlled amounts of the ³He isotope, which has a relatively larger viscosity compared with the ⁴He isotope.

FIGS. 2A-2C illustrate schematically an example system 200 that uses electrostatic gates to create electron traps and trap electrons confined near a surface of liquid helium, according to one implementation. System 200 may use some of the components of system 100 of FIG. 1. In particular, the components denoted by numbers that differ by the first digit (e.g., 1xy and 2xy) may be the same (or may implement a similar functionality) in the two systems. Liquid helium in system 200 may be supported by a substrate 202. A bottom gate 210 may be deposited on top of the substrate 202. Liquid helium (not shown explicitly) may be placed on top of substrate 202 and/or bottom gate 210 and form a film, e.g., similar to FIG. 1. The liquid helium film may be supported laterally by a set of (e.g., dielectric) banks that are similar to the banks 106 of FIG. 1. In some implementations, the banks may partition liquid helium into separate reservoirs. The reservoirs may extend over most of the lateral dimensions of system 200, in some implementations. In other implementations, the reservoirs may extend over a part of system 200. In some implementations, the reservoirs may be further broken into a number of parallel microchannels. The liquid helium may support a system of electrons confined in the vertical direction (perpendicular to the surface of helium) by electrostatic confinement forces (e.g., image forces and/or forces caused by electrodes), as explained above in conjunction with FIG. 1. Conducting guard electrodes 212 may be deposited above the insulating banks. In some implementations, guard electrodes 212 may replicate a map of the underlying insulating banks. In some implementations, the geometry of guard electrodes 212 may be different from that of the insulating banks. Guard electrodes 212 may be formed by the top gate(s). In some implementations, guard electrodes 212 may be equipotential (e.g., conducting) electrodes. In other implementations, guard electrodes 212 may consist of a plurality of disconnected regions so that different potentials (voltages) may be applied to various regions of guard electrodes 212 separately.

In a specific realization illustrated schematically in FIG. 2A, system 200 has two relatively large regions, a left reservoir 214 and a right reservoir 216, each containing 20-25 microchannel structures. Microchannel structures may have a relatively large length (e.g., ˜700 μm, in one implementation). Left reservoir 214 and right reservoir 216 may define a plurality of electron microchannels, as explained above. Reservoirs 214 and 216 may ultimately serve as the electron reservoirs for loading electrons into the electron traps. System 200 may further include a plurality of side gates, such as a side gate 218 and a side gate 220. The side gates 218 and 220 may be electrically isolated from guard electrodes 212 and from each other. In some implementations, the side gates may be separately biased with different electric potentials. The side gates may define a central microchannel 222, e.g., as illustrated by the exploded view of FIG. 2B. The central microchannel may have a shorter length compared with the dimensions of reservoirs 214 and 216. In some implementations, the length of central microchannel 222 may be 50-200 μm. The density of electrons in central microchannel 222 may be controlled, via capacitive coupling, by a voltage applied to bottom gate 210. Similarly, a width of an area of central microchannel 222 accessible to the electrons may be controlled with voltage(s) applied to side gates 218 and 220. To characterize properties of the obtained system of electrons, electric transport measurements (such as low and audio frequency conductivity and compressibility measurements, current-voltage characteristics, measurements to determine electron density, etc.) may be performed, e.g., in combination with finite element simulations, to determine the electrochemical potential, the areal electron density, and/or other quantities of the system of electrons.

The electrons floating above the surface of helium in central microchannel 222 may serve as the source of electrons for electron traps 226 shown in the exploded view of FIG. 2C. The electric field produced by (voltage-biased) side gate 218 may induce one or more boundaries for the electrons in central microchannel 222. The boundaries may delineate the limits of the lateral motion of electrons 108 floating above the surface of helium in central microchannel 222. One or more additional control gates 228 may be located outside such boundaries. A positive voltage applied to the control gate(s) 228 may make it energetically favorable for the electrons from central microchannel 222 to move to the vicinity of control gate(s) 228. Because control gate(s) 228 may have an opposite (e.g., positive) voltage compared with the potential on the side gate 218 (which may be negative), in some implementations it may be advantageous to carve out notches in the side gate 218 to lessen the counteracting effect of the negative side gate potential. In some implementations, a radio frequency single-electron transistor sensor (RF-SET sensor) 230 may be located inside electron trap 226.

An additional side microchannel leading from central microchannel 222 to electron trap 226 may be formed by a load gate 232. For example, when a positive potential is applied to load gate 232, the electrostatic attraction of the electrons to load gate 232 may open the side microchannel to the electrons from central microchannel 222 so that the electrons may fill the electron trap 226. When a negative voltage is subsequently applied to load gate 232, this negative voltage may severe the side microchannel by building a potential barrier between central microchannel 222 and electron trap 226 and trap the electrons inside electron trap 226. In some implementations, control gate(s) 228, RF-SET sensor 230, and load gate 232 may be located below the surface of helium. In some implementations, control gate(s) 228, RF-SET sensor 230, and load gate 232 may be located within the plane of bottom gate 210 and may be electrically isolated from bottom gate 210 and from each other by insulating inserts 234, as illustrated in FIG. 2C. In other implementations, at least some of control gate(s) 228, RF-SET sensor 230, load gate 232, and bottom gate 210 may be located within different planes.

Once the connection between central microchannel 222 and electron trap 226 is severed, the number of electrons trapped inside electron trap 226 may be adjusted by controlling the voltage V applied to control gate(s) 228. For example, as the gate voltage V_{g} is decreased, the potential energy of the electrons in electron trap 226 is increased (since the electron charge is negative). As a result, some electrons may be squeezed out of electron trap 226. This process may be continued until the number of electrons in electron trap 226 has reached a predetermined value. In some implementations, the predetermined value may be equal to one—a situation where a single-electron quantum qubit is realized.

In some implementations, the process of loading single electrons into the trapping region may be performed differently, with the severing of the side microchannel performed subsequently to the adjustment of the number of the electrons inside electron trap 226. For example, the loading process may be performed as follows. Initially, the electrostatic potential of the electrons in electron trap 226 and the side microchannel may be tuned to be more positive than the electrochemical potential of the electrons in reservoirs 214 and 216 and central microchannel 222. Under these conditions, the electrons may move along the side microchannel into electron trap 226. The number of electrons loaded into electron trap 226 may be estimated from the finite element modeling. Subsequently, the control gate voltage V_{g} may be swept to negative (or less positive) values. This will decrease the electrostatic potential in electron trap 226 so that the electrons will be depopulated from electron trap 226 one by one. Once the number of the electrons in the electron trap 226 has been reduced to one (or another predetermined value), the electrostatic potential along the side microchannel may be set to negative values by decreasing the voltage on loading gate 232. In some implementations, the potential inside the side microchannel may be made significantly more negative compared with the potential inside electron trap 226, e.g., in order to create a sufficiently high potential barrier preventing electrons from escaping the formed qubit back into central microchannel 222.

The RF-SET sensor 230 may be a highly sensitive radio-frequency single-electron transistor micro-fabricated onto an insulating substrate (e.g., the substrate 202) and submerged beneath the liquid helium surface. In some implementations, a high-speed quantum charge sensor may be used as the RF-SET to measure the vertical motional quantum state of an electron trapped above it (e.g., inside electron trap 226). RF-SET sensor 230 may facilitate readout of the qubit states. To achieve a high operational speed of RF-SET sensor 230, in some implementations, a conventional SET may be embedded as the capacitive component of a high-frequency microwave resonant circuit.

Electrons trapped inside a finite region (e.g., electron trap 226) may have a discrete spectrum of energies. In a qubit realization, a ground state of the electron may represent qubit state |0 [symbol] whereas one of the excited states, for example, the first excited state, may represent qubit state |1 [symbol] . In various implementations, the first excited state may correspond to various quantum motions of the electron. For such traps, the first excited state |1 [symbol] of the qubit may be the first excited state for the vertical (i.e., perpendicular to the surface of helium) motion of the trapped electron. In some traps (e.g., of smaller size), the first excited state |1 [symbol] of the qubit may be associated with the lateral motion of the trapped electron (e.g., “particle-in-a-box” quantum motion). In some implementations, a magnetic Zeeman field may be used to control qubit quantum states, with e.g., a spin-up state corresponding to state |0 [symbol] and a spin-down state corresponding to state |1 [symbol] . A superposition α|0 [symbol] +β|1 [symbol] of two states of the qubit, with quantum amplitudes α and β, may be prepared and controlled using radio frequency or microwave signals, e.g., by inducing Rabi oscillations of the amplitudes α and β.

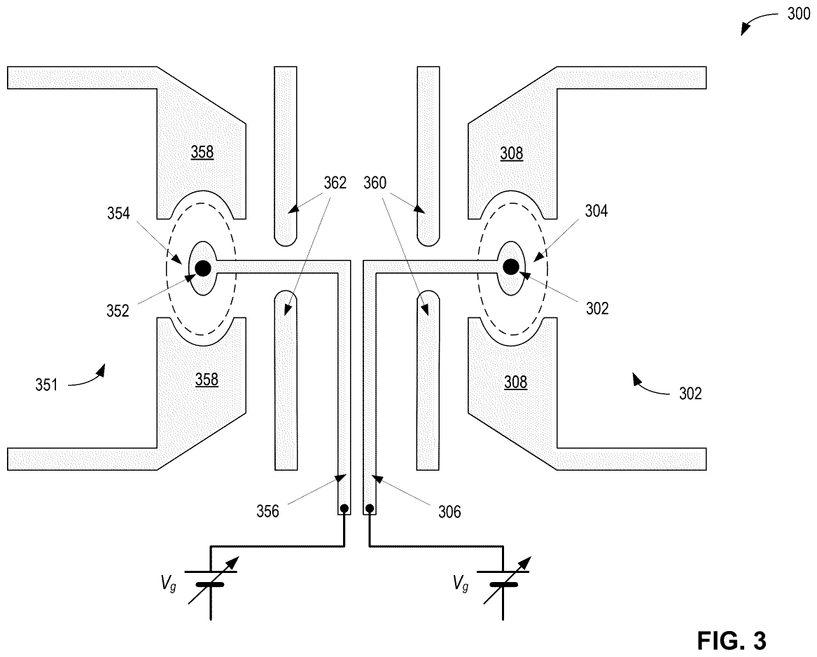

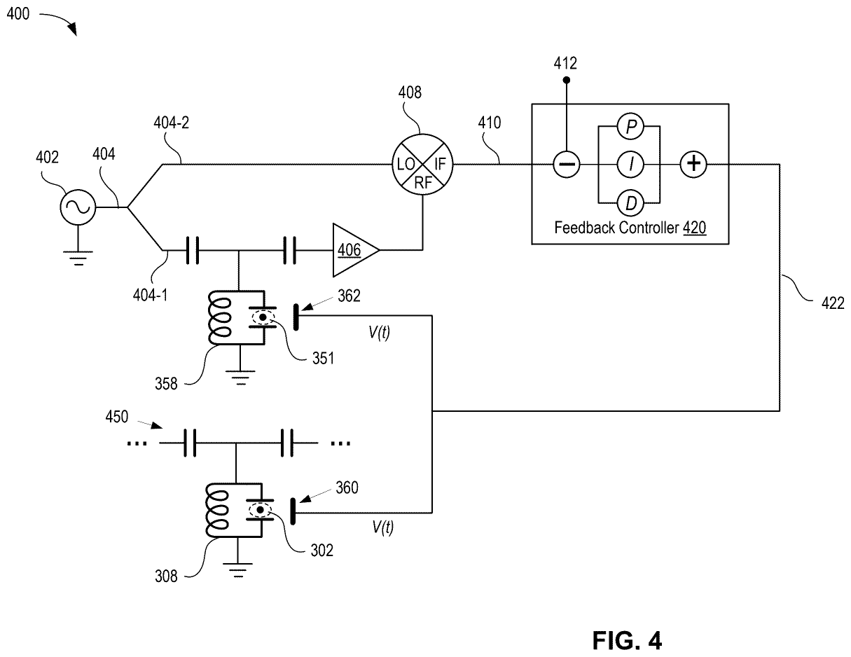

FIG. 3 illustrates an example structure 300 that includes a data qubit 302 and an ancillary qubit 351 to implement an active feedback loop that prevents environmental decoherence of data qubit 302, according to one implementation. Both data qubit 302 and ancillary qubit 351 may be implemented using helium films, microchannels, and traps, as disclosed in conjunction with FIG. 1 and FIG. 2 above. For example, data qubit 302 and ancillary qubit 351 may be implemented as part of one or more electron traps 226 of FIG. 2. Some of the components (e.g., electrodes and/or microchannels) of FIG. 2 are not shown in FIG. 3, for conciseness and ease of viewing. As illustrated in FIG. 3, data qubit 302 may use a data electron trapped in or near a trap 304 whose boundary is depicted schematically with a dashed oval. Trap 304 may be defined using a suitable confinement gate (e.g., side gate 218 in FIG. 2) or multiple confinement gates (which are not shown in FIG. 3). Data electron 302 may be delivered into trap 304 using a load gate 306 (e.g., load gate 232 in FIG. 2), e.g., by controlling a voltage V_{g} on load gate 306, as disclosed above in conjunction with FIG. 2C. Similarly, ancillary electron 352 may be trapped in a trap 354 (depicted with the corresponding dashed oval) delivered using a load gate 356. Additionally, data qubit 302 (and, similarly, ancillary qubit 351) may be capacitively coupled to electrodes that are parts of a data resonator circuit 308 (and, similarly, ancillary resonator circuit 358) described in more detail in conjunction with FIG. 4 below. Structure 300 may further include control electrodes 360 and 362 to receive a correction signal V(t) that compensates for fluctuations of electric potential of data qubit 302 and ancillary qubit 351. Structure 300 may be implemented in a symmetric (or nearly symmetric) fashion, so that various dimensions (of gates, traps, and/or the like) are the same (or nearly the same), so that the data qubit 302 and the ancillary qubit 351 have the same (or nearly the same) susceptibilities. To ensure that the data qubit 302 and the ancillary qubit 351 experience the same environment (and, correspondingly, the same fluctuations of the electric potential), the distance between trap 304 and trap 354 (e.g., center-to-center distance) may be 100 micron or less, in some implementations. In some implementations, data qubit 302 and ancillary qubit 351 may be mounted on a single chip.

FIG. 4 is a schematic block diagram of an example active feedback system 400 that compensates for environmental noise/fluctuations of electric potential and improves qubit coherence, according to one implementation. Active feedback system 400 may deploy ancillary qubit 351 to facilitate coherence of data qubit 302. Ancillary qubit 351 may be coupled (e.g., capacitively) to ancillary resonator circuit 358, which may include one or more inductors and one or more capacitors. Similarly, data qubit 302 may be coupled to data resonator circuit 308. In some implementations, data resonator circuit 308 and ancillary resonator circuit 358 may be copies of each other (or mirror copies of each other) so that data qubit 302 and ancillary qubit 351 may have the same (or approximately the same) resonant frequency v₀.

Active feedback system 400 may use a signal generator 402 to generate a continuous-wave RF signal or a MW signal, referred to jointly as RF/MW signal 404 herein, e.g., I₀(t)=A₀ cos vt. The RF/MW signal 404 may be tuned to the resonant frequency of ancillary resonator circuit 358, v=v_{RES} (or v≈v_{RES}). Signal generator 402 may be an analog synthesizer, a crystal oscillator source, a fast digital signal source, and so on. In some implementations, RF/MW signal 404 produced by signal generator 402 may be unmodulated (as in the above example). In some implementations, RF/MW signal 404 produced by signal generator 402 may be modulated. Depending on a specific type of states of qubits, the resonant frequency v_{RES} may be in the range 10 MHz-1 GHz, in some implementations. In some implementations, the resonant frequency v_{RES} may be below 10 MHz or above 1 GHz.

RF/MW signal 404 may be split into two (e.g., equal) signals, such as a probe signal 404-1 and a reference signal 404-2. Probe signal 404-1 may be used to probe a response (e.g., RF/MW impedance) of ancillary resonator circuit 358. As a result of interaction with ancillary resonator circuit 358 (and coupled to it ancillary qubit 351), probe signal 404-1 undergoes a phase shift and a change of amplitude. In some implementations, the probe signal may then be amplified by an amplifier 406, e.g., to compensate for losses of the probe signal. The amplified signal I(t)=A(t) cos(vt+0(t)) may be used as an RF input into mixer 408 and reference signal 404-2, I₀(t)=A₀ cos vt, may be used as a local oscillator (LO) input into mixer 408. In some implementations, mixer 408 may be a 3-port mixer. In some implementations, mixer 408 may be a 4-port IQ-mixer.

Mixer 408 may mix the two input signals and may output, e.g., via an intermediate frequency (IF) port, an IF signal 410 representative of the phase difference of the two input signals,

$$e . g . , {I}_{IF} ( t ) = \frac{1}{2} {A}_{0} A ( t ) cos ( ϕ ( t ) ) .$$

(The high-frequency combination of the input signals, ˜cos(2vt), may be filtered out, e.g., using a low-pass filter.) The IF signal 410 may be processed by a feedback controller 420 that generates a correction signal 422, which may deliver the same voltage signal V(t) to the vicinity of data qubit 302 and ancillary qubit 351, e.g., via respective control electrodes 360 and 362.

In some implementations, feedback controller 420 may be or include a proportional-integral-derivative (PID) controller having a set point 412 and a plurality of error-correction circuits. Set point 412 may be used as a reference signal, which may be a DC input, e.g.,

$$e . g . , {I}_{R} = \frac{1}{2} {A}_{0} {A}_{R} ,$$

in which A₀ is a reference amplitude for IF signal 410, e.g., an amplitude of the IF signal that would have existed in the absence of environmental fluctuations. PID feedback controller 420 may measure a difference Δ(t)=I_{IF}(t)−I_{R} between the IF signal 410 and the reference (set point) signal I_{R}. The difference Δ(t) may be processed by a proportional circuit (P), an integration circuit (I), and a derivative circuit (D), and the outputs of the P, I, and D circuits may be combined into correction signal 422.

Data qubit 302 may be coupled to a suitable control circuitry 450 to perform qubit initialization, gate operations, readout, and/or the like.

Operations of feedback controller 420 may amount to identifying a time-varying resonant frequency v_{RES}(t) of ancillary resonator circuit 358 from the amplitude A(t) and the phase shift φ(t), e.g., relative to the probe signal frequency, v_{RES}(t)−v. Alternatively, the real part and the imaginary parts of the signal may be identified. More specifically, with the departure of v_{RES}(t) from the probe signal frequency v (which may also be a resonant frequency of the qubits in the absence of fluctuations), the amplitude A(t) may decrease from the reference amplitude A_{R} for both signs of v_{RES}(t)−v. The phase shift φ(t) may be used to identify the direction of drift of the resonant frequency v_{RES}(t) (the sign of v_{RES}(t)−v). For example, phase shift φ(t) changes from φ(t)≈0 for the resonant frequency v_{RES}(t) substantially below the frequency v of the probe signal, to

$$ϕ ( t ) = \frac{π}{2}$$

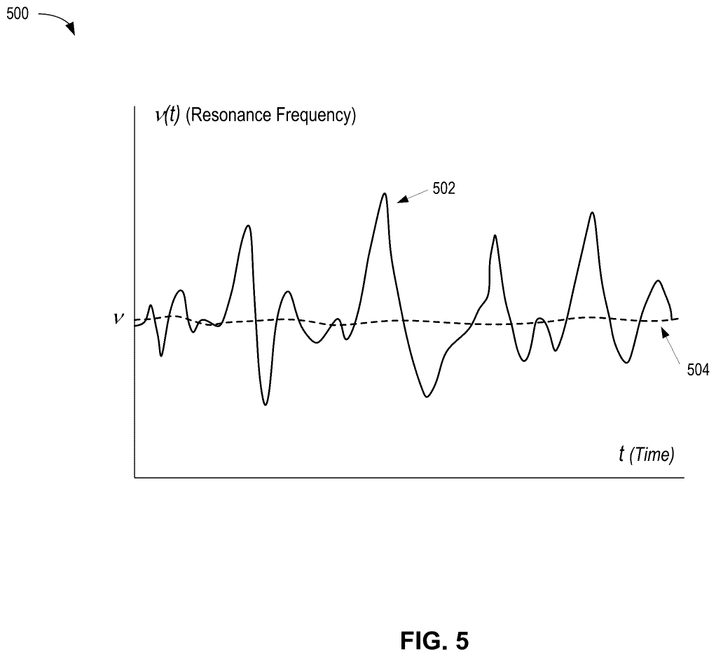

right at the resonance v_{RES}(t)=v, and then to φ(t)≈π for the resonant frequency v_{RES}(t) substantially above the frequency v of the probe signal. FIG. 5 illustrates schematically compensation 500 of fluctuations of electrostatic potential using active feedback system 400 of FIG. 4, according to one implementation. More specifically, fluctuating resonant frequency v_{RES}(t) of the ancillary qubit (and, correspondingly, of its copy, or near copy—the data qubit), which would have existed in the absence of the active feedback system, is depicted schematically with the solid curve 502. Compensation by the active feedback system results in the smoothing of the fluctuating resonant frequency v(t)—illustrated schematically with the dashed curve 504—and bringing the resonant frequency v(t) closer to frequency v.

In some implementations, two or more circuits and components of FIG. 4 can be combined into a single hardware module, e.g., any or all of signal generator 402, a splitter (that splits RF/MW signal 404 into signals 404-1 and 404-2), mixer 408, and/or feedback controller 420 may be implemented via such a module.

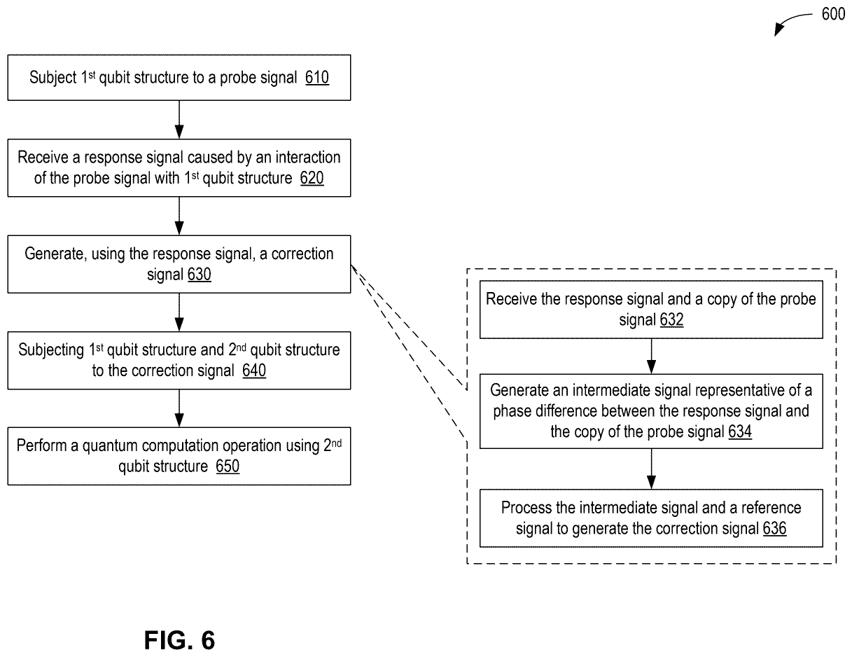

FIG. 6 is a flow diagram illustrating an example method 600 of improving qubit coherence by compensating for environmental noise/fluctuations of electric potential of qubits, according to one implementation. In some implementations, method 600 may be performed using systems and components disclosed above in relation to FIGS. 1-5. Method 600 may begin with preparing a film of liquid helium or some other condensed (liquid or solid) phase of one or more other inert gas materials. The film may be maintained in a cryostat at a temperature below a condensation temperature for the inert gas materials (e.g., below the helium condensation temperature). The film may support electrons floating near a surface of the film. For example, method 600 may include preparing a substrate with microchannels that are filled with liquid (e.g., superfluid) helium using capillary action of helium. Preparation of the film may include populating the electron subsystem with electrons from an electron source, e.g., by thermionic emission from the source. Preparation of the film may also include characterization of the system of electrons, for example, by performing measurements to determine the electrochemical potential of the system of electrons, the density (e.g., the aerial density of electrons), and/or other quantities of the system of electrons. Preparation of the film may also include placing various gates near the film. Some of the gates may be electrically isolated from the film and from the system of electrons but may be capacitively coupled to the system of electrons. Some of the gates may be in direct electric contact with the film. Some of the gates may be voltage-biased. Some of the gates may be used to create a boundary of the system of electrons. Some of the gates may be used to define one or more electron traps outside the boundary, so that the electrons in the electron traps are spatially (e.g., laterally) separated from the rest of the system of electrons and/or electrons that may reside in other electron traps.

At block 610, method 600 may include subjecting a first qubit structure (e.g., a single-electron qubit structure) to a probe signal (e.g., probe signal 404-1 in FIG. 4). The first (second, etc.) qubit structure may be formed by a first (second, etc.) set of electrodes (e.g., as illustrated in FIG. 3) electrostatically confining a first (second, etc.) electron in a direction lateral to the film of one or more inert gas elements. The first (second, etc.) electron may be confined, in a direction perpendicular to the film, by electrostatic forces of attraction to at least one of (i) the film or (ii) one or more electrodes located below the film.

In some implementations, each of the first single-electron qubit structure and the second single-electron qubit structure may include a resonator circuit (e.g., resonator circuits 308 and 358, as illustrated in FIG. 3 and FIG. 4). In some implementations, the resonator circuits may have a resonance frequency in a radio frequency range and/or a microwave range. The resonance frequency may correspond to (e.g., may be equal to or approximately equal to) a difference between an excited state energy of the first electron and a ground state energy of the first electron,

$$e . g . , {v}_{0} \approx \frac{{E}_{1} - {E}_{0}}{h} .$$

In some implementations, the probe signal may be or include a continuous in time signal. In some implementations, the continuous in time signal may have a frequency v that is close to a resonant frequency of ancillary resonator circuit 358. In some implementations, the probe signal may be a pulsed signal, e.g., the probe signal may be a stroboscopic signal that generates a semi-continuous record of the resonant frequency of the first qubit structure. The carrier frequency v of the pulsed signal can also be close to the resonant frequency v_{RES} of ancillary resonator circuit 358. In one example non-limiting implementation, a pulse length may be selected to be close to

$$\frac{2}{κ} ,$$

where κ is a bandwidth of ancillary resonator circuit 358. This may correspond to pulse durations within 0.1-20 μs for most devices. A spacing (delay) between pulses may be at least twice the pulse duration, to allow the electromagnetic field ancillary resonator circuit 358 to decrease to zero amplitudes (or close to zero amplitudes).

At block 620, method 600 may include receiving a response signal caused by an interaction of the probe signal with the first single-electron qubit structure (e.g., serving as the ancillary qubit).

At block 630, method 600 may continue with generating, using the response signal, a correction signal. In some implementations, operations of block 630 may be performed as further illustrated with the callout portion of FIG. 6. More specifically, at block 632, generating the correction signal may include receiving (e.g., using mixer 408) the response signal (as the LO input) and a copy of the probe signal (as the RF input). At block 634, method 600 may include generating, e.g., using mixer 408, an intermediate signal (e.g., IF signal 410 in FIG. 4) representative of a phase difference between the response signal and the copy of the probe signal. The phase difference φ(t) may be representative of noise (fluctuations) of the resonant frequency of the first single-electron qubit structure. At block 636, method 600 may include processing the intermediate signal and a reference signal (e.g., set-point 412 in FIG. 4) using a proportional-integral-derivative (PID) controller, to generate a correction signal (e.g., correction signal 422 in FIG. 4). In some implementations, the correction signal generated by the PID controller may be configured to reduce a difference between the intermediate signal and the reference signal.

At block 640, method 600 may continue with subjecting the first qubit structure and the second qubit structure to the correction signal. At block 650, method 600 may include performing a quantum computation operation using the second (coherence-stabilized) qubit. The quantum computation operation may include initializing a state of the second qubit, performing one or more quantum gate operations with the second qubit, reading out the final state of the second qubit, and/or performing any other suitable operations.

It should be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

The implementations of methods, hardware, software, firmware or code set forth above may be implemented via instructions or code stored on a machine-accessible, machine readable, computer accessible, or computer readable medium which are executable by a processing element coupled to memory. “Memory” includes any mechanism that provides (i.e., stores and/or transmits) information in a form readable by a machine, such as a computer or electronic system. For example, “memory” includes random-access memory (RAM), such as static RAM (SRAM) or dynamic RAM (DRAM); ROM; magnetic or optical storage medium; flash memory devices; electrical storage devices; optical storage devices; acoustical storage devices, and any type of tangible machine-readable medium suitable for storing or transmitting electronic instructions or information in a form readable by a machine (e.g., a computer).

Reference throughout this specification to “one implementation” or “an implementation” means that a particular feature, structure, or characteristic described in connection with the implementation is included in at least one implementation of the disclosure. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

In the foregoing specification, a detailed description has been given with reference to specific exemplary implementations. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of implementation, embodiment, and/or other exemplarily language does not necessarily refer to the same implementation or the same example, but may refer to different and distinct implementations, as well as potentially the same implementation.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

What is claimed is:

1. A processing device comprising:
a first qubit structure formed using a first set of electrodes electrostatically confining a first electron in a direction lateral to a film, wherein the film comprising a condensed phase of one or more inert gas elements;
a second qubit structure formed using a second set of electrodes electrostatically confining a second electron in the direction lateral to the film;
a feedback circuitry to:
subject the first qubit structure to a probe signal;
receive a response signal caused by an interaction of the probe signal with the first qubit structure;
generate, using the response signal, a correction signal; and
subject the first qubit structure and the second qubit structure to the correction signal.

2. The processing device of claim 1, wherein the first electron and the second electron are confined, in a direction perpendicular to the film, by electrostatic forces of attraction to at least one of (i) the film or (ii) one or more electrodes located below the film.

3. The processing device of claim 1, wherein each of the first qubit structure and the second qubit structure comprises a resonator circuit.

4. The processing device of claim 3, wherein the resonator circuit has a resonance frequency in at least one of a radio frequency range or a microwave range, and wherein the resonance frequency corresponds to a difference between an excited state energy of the first electron and a ground state energy of the first electron.

5. The processing device of claim 1, wherein the probe signal comprises at least one of:
a continuous in time signal; or
a pulsed signal.

6. The processing device of claim 5, wherein the probe signal comprises the continuous in time signal having a frequency that corresponds to a resonant frequency of the first qubit structure.

7. The processing device of claim 1, wherein the feedback circuitry comprises a mixer to:
receive the response signal and a copy of the probe signal; and
generate an intermediate signal representative of a phase difference between the response signal and the copy of the probe signal, the phase difference representative of noise of a resonant frequency of the first qubit structure.

8. The processing device of claim 7, wherein the feedback circuitry further comprises a proportional-integral-derivative (PID) controller to:
generate the correction signal, wherein the correction signal is generated using the intermediate signal and a reference signal.

9. The processing device of claim 8, wherein the correction signal generated by the PID controller is configured to reduce a difference between the intermediate signal and the reference signal.

10. The processing device of claim 1, wherein the one or more inert gas elements comprise helium.

11. A method comprising:
subjecting a first qubit structure to a probe signal, wherein the first qubit structure is formed by a first set of electrodes electrostatically confining a first electron in a direction lateral to a film, wherein the film comprising a condensed phase of one or more inert gas elements;
receiving a response signal caused by an interaction of the probe signal with the first qubit structure;
generating, using the response signal, a correction signal; and
subjecting the first qubit structure and a second qubit structure to the correction signal, wherein the second qubit structure is formed using a second set of electrodes electrostatically confining a second electron in the direction lateral to the film.

12. The method of claim 11, wherein the first electron and the second electron are confined, in a direction perpendicular to the film, by electrostatic forces of attraction to at least one of (i) the film or (ii) one or more electrodes located below the film.

13. The method of claim 11, wherein each of the first qubit structure and the second qubit structure comprises a resonator circuit.

14. The method of claim 13, wherein the resonator circuit has a resonance frequency in at least one of a radio frequency range or a microwave range, and wherein the resonance frequency corresponds to a difference between an excited state energy of the first electron and a ground state energy of the first electron.

15. The method of claim 11, wherein the probe signal comprises at least one of:
a continuous in time signal, or
a pulsed signal.

16. The method of claim 15, wherein the probe signal comprises the continuous in time signal having a frequency that corresponds to a resonant frequency of the first qubit structure.

17. The method of claim 11, wherein generating the correction signal comprises:
receiving the response signal and a copy of the probe signal; and
generating, using a mixer, an intermediate signal representative of a phase difference between the response signal and the copy of the probe signal, wherein the phase difference is representative of noise of a resonant frequency of the first qubit structure.

18. The method of claim 17, further comprising:
processing, using a proportional-integral-derivative (PID) controller, the intermediate signal and a reference signal to generate the correction signal.

19. The method of claim 18, wherein the correction signal generated by the PID controller is configured to reduce a difference between the intermediate signal and the reference signal.

20. A system comprising:
a cryostat to maintain a film of liquid helium at a temperature below helium condensation temperature;
a plurality of single-electron qubit structures, each of the plurality of single-electron qubit structures formed using a respective set of one or more electrodes electrostatically confining a first electron in a direction lateral to the film of liquid helium;
a feedback circuitry to:
subject a first single-electron qubit structure of the plurality of single-electron qubit structures to a probe signal;
receive a response signal caused by an interaction of the probe signal with the first single-electron qubit structure;
generate, using the response signal, a correction signal; and
subject the first single-electron qubit structure and a second single-electron qubit structure of the plurality of single-electron qubit structures to the correction signal.
